(19) United States
(12) Patent Application Publication
(10) Pub. No.: US 2025/0028812 A1
(43) Pub. Date: Jan. 23, 2025

(54) ELECTRONIC COMPONENT AUTHENTICITY IDENTIFICATION SYSTEM AND RELATED METHODS

(71) Applicant: UNIVERSITY OF SOUTH FLORIDA, Tampa, FL (US)

(72) Inventors: Yunghsiao CHUNG, New Port Richey, FL (US); Feng YU, Lutz, FL (US); Stephen Edward SADDOW, Vista Circle, FL (US); Junjie XIONG, Tampa, FL (US)

(21) Appl. No.: 18/713,166

(22) PCT Filed: Nov. 23, 2022
(86) PCT No.: PCT/US22/80455

§ 371 Date: May 23, 2024

Related U.S. Application Data
(60) Provisional application No. 63/282,530, filed on Nov. 23, 2021.

(51) Int. Cl. G06F 21/44

(52) U.S. Cl. CPC G06F 21/44

(57) ABSTRACT

A method and a system for identifying authenticity of an electronic component is disclosed. The method may include obtaining chip data of an electronic component: extracting feature information of the chip data for reducing noise of the chip data: providing the feature information of the chip data to a trained deep learning model; and providing a user with an authenticity indication for the electronic component based on an output of the deep learning model. Other aspects, embodiments, and features are also claimed and described.

### CROSS-REFERENCE TO RELATED APPLICATION

This application claims the benefit of U.S. Provisional Patent Application Ser. No. 63/282,530, filed Nov. 23, 2021, the disclosure of which is hereby incorporated by reference in its entirety, including all figures, tables, and drawings

### TECHNICAL FIELD

The technology discussed below relates generally to authentication of electronic components.

### BACKGROUND

Counterfeit electronics are both an extremely serious and common issue in the global systems supply chain which increases the risk of critical system errors and failure which can even be life-threatening. Systems affected range from modern mobile devices (cell phones, tablets, etc.), computers and laptops, medical diagnostic and treatment systems, air traffic control and GPS systems, etc. Critical systems have a long-life cycle and often use obsolete ‘legacy’ devices which makes them a target for counterfeit parts due to economic reasons. For example, reproducing legacy parts is both expensive and time consuming due to advances in the manufacturing chain that made these parts obsolete in the first place. In addition, using obsolete parts often leads to quality conformance issues even if the part is legitimate since some of the electronics might have been sitting on the shelf (e.g., for over 20 years).

Purchasing electronic parts directly from part manufacturers and their authorized suppliers is the lowest risk step in the procurement of parts for critical systems. However, for various reasons, such as obsolete parts, short lead times, etc., parts are often purchased from unauthorized sources or brokers. This alone may put an entire system that uses the replacement part at risk. Counterfeit integrated circuit (IC) chips and quality conformance of microelectronics are big challenges. Furthermore, being able to identify counterfeit parts in the supply chain is extremely challenging, time consuming, and expensive. What are needed are systems and methods that address one or more of these shortcomings.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one example, a method for authenticity identification of the electronic component is disclosed. The method includes obtaining chip data of an electronic component; extracting feature information of the chip data for reducing noise of the chip data; providing the feature information of the chip data to a trained deep learning model; and providing a user with an authenticity indication for the electronic component based on an output of the deep learning model.

In another example, an electronic component authenticity identification system is disclosed. The system includes: a socket for receiving an electronic component, a processor, a memory having stored thereon a set of instructions which, when executed by the processor, cause the processor to: obtain chip data of the electronic component by providing a voltage to each pin-to-pin connection of the electronic component; extract feature information of the chip data; provide the feature information of the chip data to a trained deep learning model; and provide a user with an authenticity indication for the electronic component based on an output of the deep learning model.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a conceptual illustration of an example of an electronic component authenticity identification system according to some embodiments.

FIG. 2 illustrates a subfile showing pin-to-pin waveform data according to some embodiments.

FIGS. 3A and 3B illustrate examples of original chip data and feature-extracted and noise-reduced chip data according to some embodiments.

FIGS. 4A and 4B illustrate examples of original time-series waveform data of a pin to another pin of an electronic component and feature-extracted and noise-reduced time-series waveform data according to some embodiments.

FIG. 5 illustrates an example of a deep learning model of an electronic component authenticity identification system according to some embodiments.

FIG. 6 illustrates a conceptual illustration of an example of a deep learning model according to some embodiments.

FIG. 7 illustrates an example of a programming code implementing a deep learning model according to some embodiments.

FIG. 8 is a flow chart illustrating an exemplary process for detecting authenticity of an electronic component according to some embodiments.

FIG. 9 is a block diagram conceptually illustrating an example of a hardware implementation for the methods disclosed herein.

FIGS. 10A-10D illustrate an example apparatus for electronic component authenticity identification according to some embodiments.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Counterfeit electronics is both an extremely serious and a very common issue in the global systems supply chain which increases the risk of critical system errors and failures which can even be life-threatening. Affected systems range from modern mobile devices (cell phones, tablets, etc.), computers & laptops, medical diagnostic & treatment systems, air traffic control & GPS systems, etc. Critical systems typically have a long life cycle (decades) and often use obsolete ‘legacy’ devices which makes them a target for counterfeit parts due to economic reasons. For example, reproducing legacy parts is both expensive and time consuming due to advances in the manufacturing chain that made these parts obsolete in the first place. In addition, using obsolete parts often leads to quality conformance issues, even if the part is legitimate, since some of the electronics might have been sitting on the shelf for over twenty years.

Purchasing electronic parts directly from part manufacturers and their authorized suppliers can be a low risk step in the procurement of parts for critical systems. However, for various reasons such as an obsolete part, short lead time, etc., parts may be purchased from unauthorized sources or brokers, which can put an entire system that uses the replacement part at risk. For existing systems, some manufacturers often create an ID code in the device memory or microcontroller to prevent counterfeit electronics from being inserted into critical systems. This ID code can be a serial binary code stored in an unerasable or unchangeable register of the device memory. Users must use technical ways such as a JTAG (Joint Test Action Group) interface, Serial Peripheral Interface (SPI), or Inter-Integrated Circuit (I2C) to find this information. Such actions are usually performed by professional engineers and require extra setup and lead time. The electronic component authentication identification system 100 described below may reduce time to identify counterfeit electronics without human intervention and efficiently and effectively identify counterfeit electronics with a low cost. For example, using embodiments of the present disclosure, qualified personnel without a strong electronics background can therefore perform quick screen testing, which can save time and expense which is normally needed to set up and develop a testing regimen for microelectronics. The disclosed approach offers several benefits to determine its authenticity of an electronic component based on a deep learning technique and the capability of being utilized by operators who may not have achieved a high skill level as electronics experts. In contrast, conventional electronics assessment can require highly skilled electronics experts, a fact which both increases cost to testing and slows down part assessment.

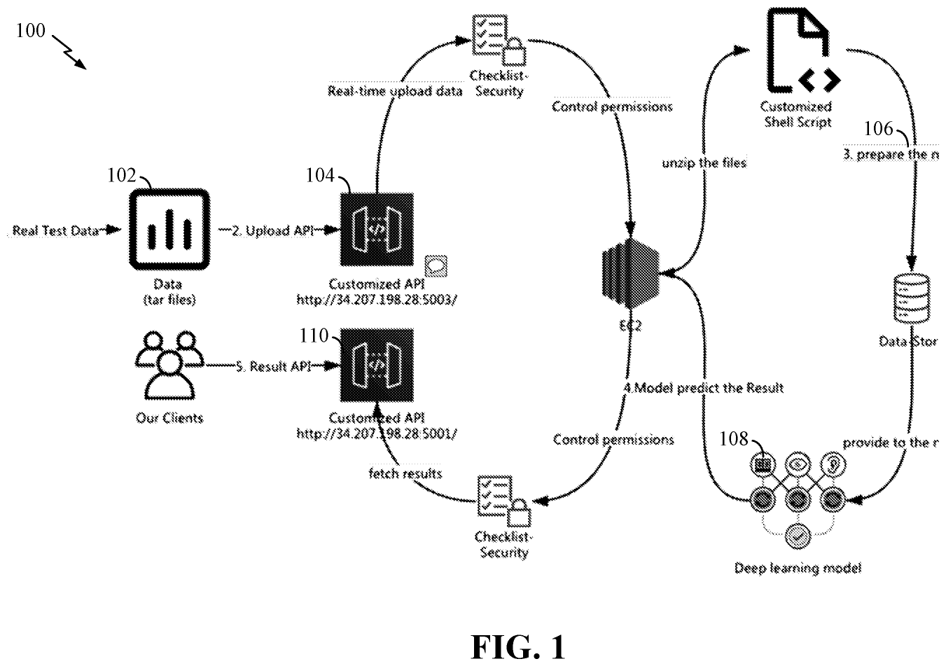

FIG. 1 is a conceptual illustration of an example of an electronic component authenticity identification system 100 according to an aspect of the disclosure. The electronic component authenticity identification may extract features from known-good data of a known-good chip and counterfeit integrated chip (IC) physical pin characteristics data, adjust weights of a system model based on the features, determine the boundary of the known-good chip, and/or detect whether the electronic component is a counterfeit or not. For example, the system 100 may perform 5 steps. For example, 1) the system 100 may compress all the subfiles (102), 2) upload the subfiles into a database along with permission control (104). After that, the system 100 May 3) preprocess originally uploaded subfiles (106). In some examples, the preprocessing of the compressed file may include noise reduction and feature extraction. At a given point in time, the system 100 May 4) train and use a deep learning model to improve its performance (108). Finally, the system 100 May 5) provide an authenticity result or indication based on the evaluation data and its performance (110).

In some examples, the system 100 may include a socket to receive an electronic component. The electronic component may be a target chip to be ultimately determined to be authentic or counterfeit. The electronic component may be configured to be received by the socket (e.g., chip socket receiver) of the authenticity identification system 100. The electronic component may include an integrated circuit (IC) chip. For example, the electronic component may include a digital IC chip (e.g., a microprocessor, a digital signal processor (DSP), a microcontroller, a memory chip, an interface IC chip, a power management IC chip, and a programmable device), an analog IC chip (e.g., a sensor, a power management circuit, or an operational amplifier (op-amp)), or a mixed-signal IC chip (e.g., an analog/digital converter, a digital/analog converter, or a digital potentiometer, a clock/timing IC chip, a switched capacitor (SC) circuit, and radio frequency complementary metal-oxide-semiconductor (RF CMOS) circuit.). However, it should be appreciated that the types of electronic component are mere examples. The electronic component may be any other suitable physical entity that affects electrons. In some instances, the electronic component may include multiple pins. Each of pins in the electronic component may be received by the socket and electrically coupled to the system 100. In some examples, based on the physical setup of the electronic component into the socket, the system 100 can provide an automated test and diagnostic system to rapidly scan between pins thus forming an ‘electronic signature’ of the electronic component, part, or device under test (DUT) based on a deep learning technique. The electronic signature can then be compared to expected signature for a golden design (known authentic device) and fast assessment of the authenticity of an unknown electronic component is thus possible.

After receiving the electronic component, the system 100 may obtain chip data of the electronic component. For example, the system 100 may provide an alternating voltage (AC) to each pin-to-pin connection. In other examples, the system 100 may provide various voltages to each pin-to-pin connection. In some examples, the system 100 may scan the electronic component twice and store two types of data for library: 1) The first type of data is the matching resistance required between each pin and pin, which is obtained by the first scan, and 2) the second type of data is the test data, which uses the matching resistance configuration generated by the first scan to scan the known good data between each pin-to-pin. In various embodiments, the system 100 can conduct a quick open/short circuit check, leakage current check, and/or supply current check to make sure all the readings are within specification. The electronic component may have multiple pins that serve as electrical inputs/outputs and connect to the system through a printed circuit board. As such, the system 100 can use a matrix scan approach to scan from pin to pin of the integrated circuit to obtain physical characteristics (e.g., impedance-based characteristics) and convert some (or all) of the data to a unique identifier (e.g., ID code, electronic signature) by comparing each device or component to identifiers in a data store (e.g., reference identifiers for a known authentic or “good” device).

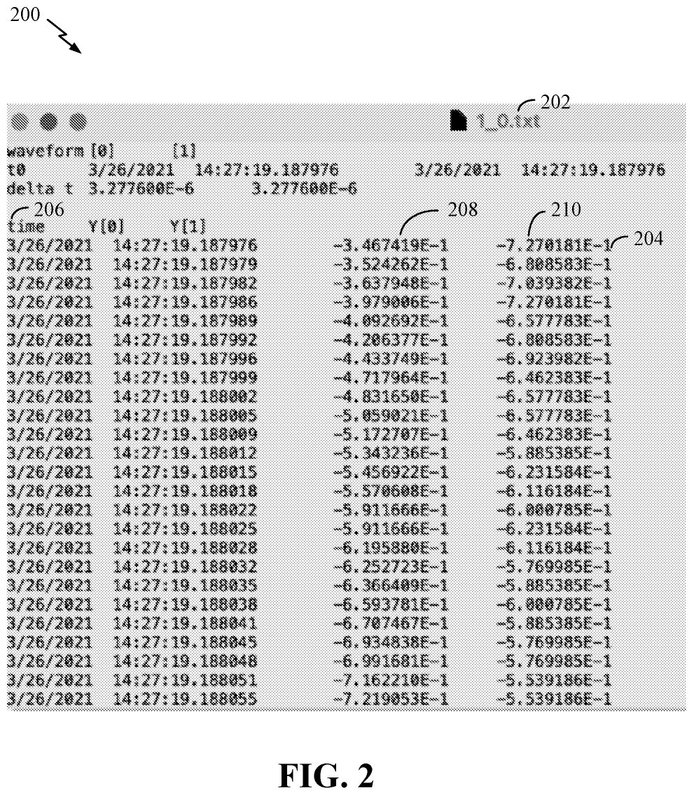

In some aspects of this disclosure, the chip data is stored in multiple subfiles that include time-series waveform data mapped from each pin of the electronic component to another pin of the electronic component. FIG. 2 illustrates a subfile showing pin-to-pin waveform data according to an aspect of the disclosure. In some examples, one subfile 202 may include chip data of each pin to another pin of the electronic component. In such examples, the one subfile 202 may also include multiple rows 204 indicating chip data. Each row may include waveform data of the same pin to a different pin. The subfile 202 may include the time 206 to test a pin to another pin chip data and levels 208 of voltages at the time. For example, the subfile 202 may include a row including a time 206, input waveform data at the time 208, and output waveform data 210 at the time. In some examples, the system may compress all subfiles to include chip data of each pin to each pin of the electronic component into one compressed file. In some examples, the chip data may include the one compressed file. By compressing subfiles, the system may transfer the compressed file to a server (e.g., a cloud server) faster than subfiles without compression. In some scenarios, the one file may be one unit of data to be processed. In other scenarios, the system 100 may use all subfiles without compressing the subfiles of the electronic component.

In some examples, the system 100 may include a server. In some examples, the server may include a cloud server, a physical server, or any other suitable computing device to process the one compressed waveform data file based on a deep learning model. In some embodiments, the server may indicate a processor and a memory in the system. In some examples, the server may receive the compressed file or one or more subfiles. In some scenarios, the system 100 may exploit a customized application programming interface (API) for controlling a permission to a user. The user may insert the electronic component in the socket and want to know whether the electronic component is counterfeit. In some instances, the system 100 may control the permission to use the system based on location information of a user of the electronic component. For example, the location information may include an internet protocol (IP) address. Thus, the system 100 may control a permission to use the system 100 based on the IP address of the user. Thus, the system 100 may not obtain the chip data when the permission is denied to the user. However, it should be appreciated that controlling a permission is not limited to the location information. The system 100 may use a system password or any other suitable technique to control the permission to a user.

In further scenarios, the system 100 may utilize the customized API for uploading and receiving a result from a server. In some embodiments, the system 100 may use one API for uploading one compressed file and receiving a result from the server. In other embodiments, the system 100 may use separate APIs. An upload API may be for uploading one compressed file or multiple subfiles. Thus, the upload API may input one compressed file or multiple subfiles and output a state code (e.g., success, fail, and/or permission control's feedback (allowed or denied)). Another result API may be for obtaining a result from the server. Thus, the result API may input one label including an electronic component's type (e.g., chip type), and/or a uploaded timestamp and output a result including array data indicating which pin to pin fails to be detected by the system 100. In other examples, the multiple subfiles or compressed file may be stored in a memory of the system 100.

Returning to FIG. 1, the system 100 may preprocess originally uploaded subfiles. The preprocessing of the compressed file may include noise reduction and feature extraction. Due to the interference of hardware acquisition and other factors, the chip data (original data) in the compressed file may contain noise that impacts the deep learning model performance. Thus, the system may extract feature information of the chip data to reduce noise of the chip data. In some examples, the system may exploit a polynomial function to reduce noise of the chip data. The polynomial function for extracting the feature information may by p(x)=Σᵢ₌₀ⁿαᵢxⁱ, where p(x) is an extracted feature, αᵢ is a coefficient that minimizes a mean squared error, xⁱ is the chip data, and n is a degree. The degree may indicate a degree of the fitting polynomial. In some examples, the system 100 may use the degree as 17 to provide one of the best results. The degree of 17 is determined based on the feature extraction result as the feature extraction result is sent to a long short-term memory (LSTM) model. In further examples, the coefficient may be calculated by: E=Σⱼwⱼ²×|yⱼ−p(xⱼ)|², where E is an extracted feature, wⱼ is a weight, yⱼ is an observed value, p(xⱼ) is the polynomial function. This may be determined by an over-determined matrix equation: V(x)×c=w×y, where V(x) is a weighted pseudo Vandermonde matrix of x, c is the coefficient to be determined, w is a weight, and y is an observed value. This equation can be applied to the chip data, the system 100 may extract feature information based on the applied equation. In some examples, the feature information may be extracted from the chip data. Then, due to some noise introduced from hardware components, the polynomial function to reduce the noise for achieving accurate results of the LSTM model. The polynomial function may be used in mathematical fitting methods to maximize reduction of collected waveform data.

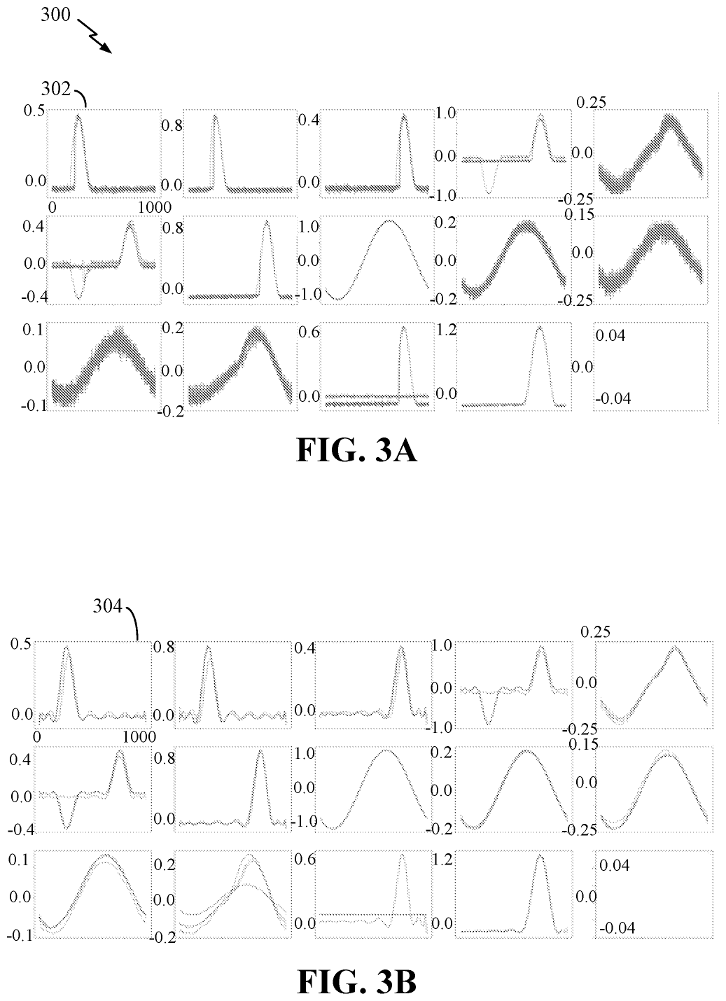

FIGS. 3A and 3B illustrate examples of original chip data and feature-extracted and noise-reduced chip data according to an aspect of the disclosure. In some example, the original chip data may include pin-to-pin time-series waveform data and extracted and the feature-extracted and noise-reduced chip data may include noise-reduced time-series waveform data. For example, each waveform 302 shown in FIG. 3A may indicate a time-series waveform data mapped from a pin to another pin of the electronic component. As shown in FIG. 3A, the time-series waveform data includes noises and the waveform have various values for a certain time that indicates that the waveform is affected by unwanted interference. However, the system 100 may reduce the noise in the original chip data and reshape the original chip data of each pin-to-pin time-series waveforms into the same dimension to be the feature information to feed the deep learning model of the system 100. After extracting the feature information and reducing noise of the chip data using the polynomial function described above, FIG. 3B shows the time-series waveform data 304 with decreased noise. The time-series waveform with decreased noise may be input to the deep learning model of the system 100.

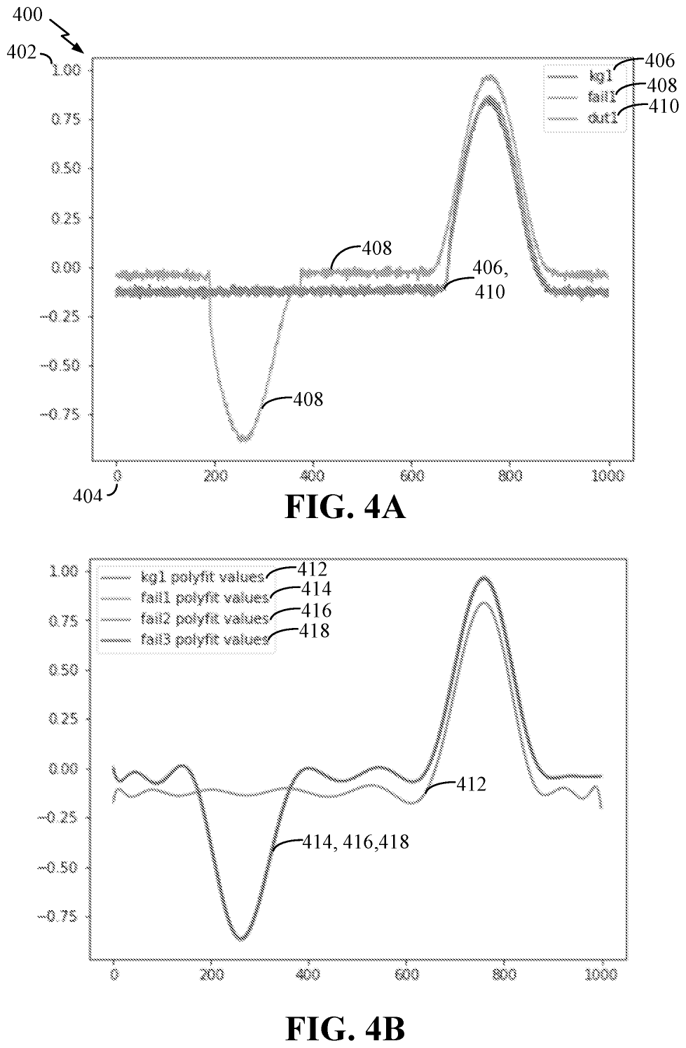

FIGS. 4A and 4B illustrate examples of an original time-series waveform data of a pin to another pin of the electronic component and feature-extracted and noise-reduced time-series waveform data according to an aspect of the disclosure. In some examples, the x-axis 404 of FIGS. 4A and 4B may indicate the sample time from (15:39:02.941604) to (15:39:02.942603) the total number is 1000. The unit is 1s/1,000,000=1 us, and the y-axis 402 of FIGS. 4A and 4B may indicate the waveform data obtained from the tests. The unit of y-axis is Volt (V). Further, kg1 406 of FIG. 4A indicates a sample of known-good waveform data, fail1 408 of FIG. 4A indicates a sample of failure chip waveform data, and dut1 410 of FIG. 4A indicates a sample of device under-test waveform data. Further, kg1 polyfit values (412) of FIG. 4B indicates know-good waveform data after noise reduction function, fail1 polyfit values (414) of FIG. 4B indicates failure chip1 waveform data after noise reduction function, fail2 polyfit values (416) of FIG. 4B indicates failure chip2 waveform data after noise reduction function and fail3 polyfit values (418) of FIG. 4B indicates failure chip3 waveform data after noise reduction function.

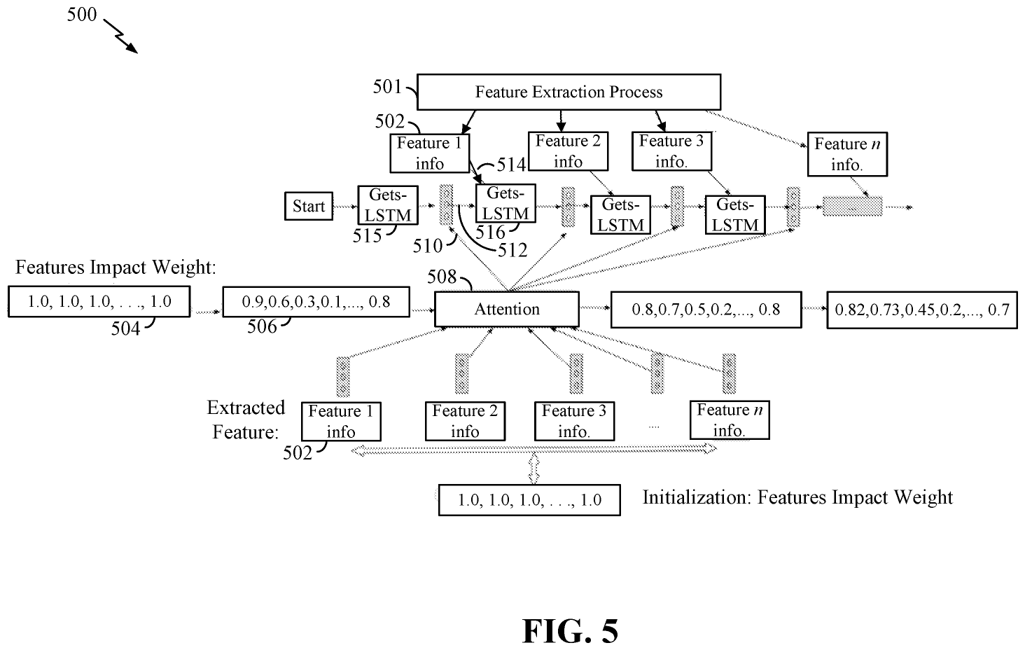

FIG. 5 illustrates an example of a deep learning model 500 of the electronic component authenticity identification system according to an aspect of the disclosure. In some examples, the system may extract feature information of the chip data by reducing noise of original chip data as explained above. The extracted feature information may include multiple features 502. Each feature may indicate a signal characteristic or a reduced-noise waveform mapped from a pin to another pin of the electronic component. In some examples, the features can be auto-extracted by the deep learning model: from the data perspective, each extracted feature can be represented by a fixed length of extracted waveform data; from the functionality perspective, some of the extracted features can indicate a signal range of change characteristic when given a specific range of input trigger. In some examples, each feature 502 may have a different impact weight on the deep learning model 500. The system 100 may adjust the multiple impact weights corresponding to multiple features using an attention mechanism 508. In some scenarios, the multiple impact weights may be included in a weight array 504, 506. The weight array 504 may, for example, adjust impact weights based on the corresponding multiple features in each training step of the deep learning model 500. For example, the system may initialize each entry of the weight array 504 as 1.0. While each training step of the deep learning model 500 of the system 100, the attention mechanism 508 may update the weight array in each step. Here, in the attention mechanism 508, its weights are computed by normalizing the output scores of a feedforward neural network described by a function that captures the alignment between inputs and outputs. For example, first, the initialized influence weights are (1.0, 1.0, 1.0), and when the features are first trained, the model adjusts the weights based on the output scores of the feedforward neural network. Just like finding which part of the features is more important for the final prediction, the weight-result is finally obtained after several rounds of training.

In further examples, the adjusted or updated weight array including impact weights corresponding to multiple features 510 may be input into multiple deep learning models 516 corresponding to multiple features 502. In some examples, FIG. 5 shows that there are multiple Gets-LSTM corresponding to multiple extracted features, thus, a Gets-LSTM may correspond to a different extracted feature, an output of the Gets-LSTM corresponding to a feature becomes an input of another Gets-LSTM corresponding to another feature, that means the last gets-LSTM may be affected by all features while the first Gets-LSTM might not be affected by any feature. Thus, a deep learning model 516 (e.g., Gets Long Short-Term Memory (Gets-LSTM) model) may, for example, receive a corresponding impact weight 510 by the attention mechanism 508, an output 512 from a previous deep learning model 515 (e.g., Gets-LSTM model) corresponding to another feature, and a corresponding feature 514 of the extracted feature information 501. The deep learning model 516 may include three gates: input gate, forget gate, and output gate. Further, the deep learning model 516 may additionally include another input gate based on the attention mechanism. This may add more extracted feature information into the deep learning model 516 and enhance its learning ability.

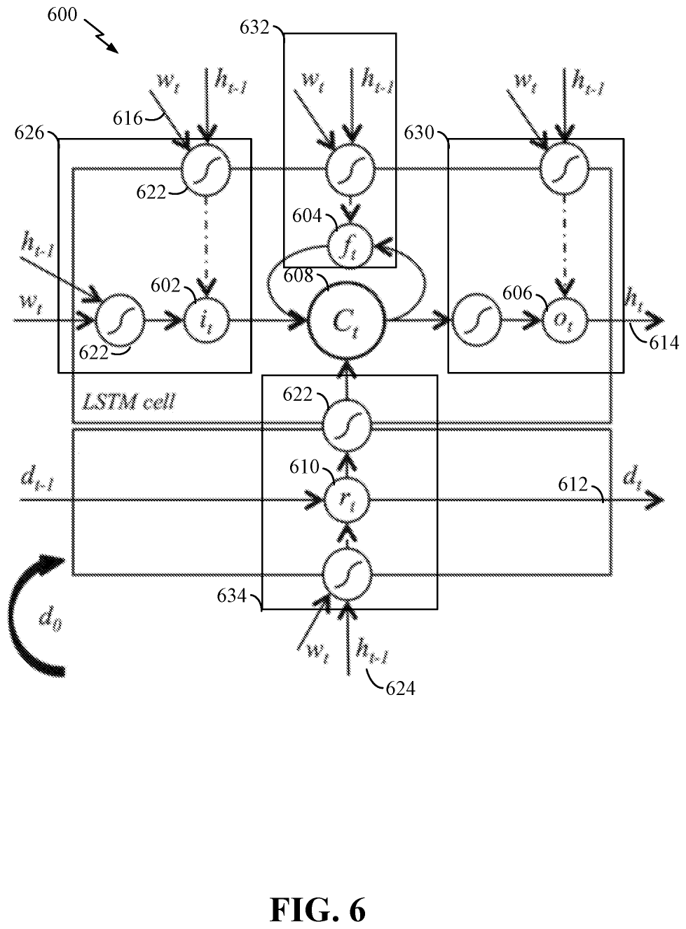

FIG. 6 illustrates a conceptual illustration of an example of a deep learning model 600 according to an aspect of the disclosure. In some examples, the deep learning model may include an artificial recurrent neural network (RNN) architecture using an input gate (e.g. iₜ 602), an output gate (e.g., oₜ 606), a forget gate (e.g., fₜ 604), and a new input gate (e.g., rₜ 610). In some scenarios, the output gate of the deep learning model may correspond to a result indicating whether the electronic component is counterfeit or authentic. The input gate may, for example, correspond to the plurality of features. The forget gate may, for example, be determined based on an input vector (e.g., wₜ 616) and a hidden state vector (e.g., hₜ 614). The new input gate may, for example, be determined based on the input vector and the hidden state vector. In some examples, the input gate may include an input gate's activation vector (iₜ 602) given by: iₜ=σ(W_{wi}Wₜ+Wₕᵢhₜ₋₁), where W_{wi} may indicate input gate weight matrices that are to be learned during training, w, may indicate an input vector to the deep learning model 600, Wₕᵢ may indicate hidden weight matrices at input gate that is to be learned during training, and hₜ₋₁ may indicate a hidden state vector at time t−1. In further examples, the forget gate may include an forget gate's activation vector (fₜ 604) given by: fₜ=σ(W_{wf}Wₜ+W_{nf}hₜ₋₁), where W_{wf} may indicate forget gate weight matrices that are to be learned during training, and Why may indicate hidden weight matrices at forget gate that are to be learned during training. In further examples, the output gate may include an output gate's activation vector (σₜ 606) given by: oₜ=σ(W_{wo}Wₜ+Wₕₒhₜ₋₁), where W_{wo} may indicate output gate weight matrices that are to be learned during training, and Wₕₒ may indicate hidden weight matrices at output gate that are to be learned during training. In even further examples, the new input gate may include a new input gate's activation vector (rₜ 610) given by: rₜ=σ(W_{wr}Wₜ+Wₕᵣhₜ₋₁), where W_{wr} may indicate feature weight matrices that are to be learned during training, and Wₕᵣ may indicate hidden weight matrices that are to be learned during training. In even further examples, a cell state vector (e.g., cₜ 608) may be given by: cₜ=fₜo cₜ₋₁+iₜ o čₜ+σ(W_{dc}dₜ). Here, the cell state vector 608 may increase the learning ability by considering the control vector di. Here, čₜ=σ(W_{c}Wₜ+W_{hc}hₜ₋₁), where We may indicate weight matrices that are to be learned during training, and W_{hc} may indicate hidden weight matrices that are to be learned during training. In further examples, a control vector may be an input to the new input gate 610 given by: dₜ=dₜ₋₁ o rₜ, where rₜ may indicate a new input gate 610. In some instance, the control vector may decide what information should be retained for future time steps and discard other information. In further examples, the hidden state vector 614 may be generated based on an output of the output gate 606 given by: hₜ=oₜ o σ(cₜ), where o may indicate Sigmod function=1/(1+e^{-x}). Based on the deep learning model, the system 100 may train the deep learning model with known-good chips or a gold chip library to produce a boundary between a known-good chip and a counterfeit chip and determine whether an electronic component received in the socket of the system 100 is authentic or counterfeit.

It should be appreciated that the deep learning model is not limited to the example above. For example, the deep learning model may be configured to implement various different types of machine learning algorithms or models. For example, the system 100 may implement decision tree learning, association rule learning, artificial neural networks, recurrent neural networks, long short-term memory models, inductive logic programming, support vector machines, clustering, Bayesian networks, reinforcement learning, representation learning, similarity and metric learning, sparse dictionary learning, genetic algorithms, k-nearest neighbors (“KNN”) classifiers, among others, such as those listed in Table 1 below.

TABLE 1

| | |
|---|---|
| Recurrent Models | Recurrent neural networks (“RNNs”), long short-term |
| | memory (“LSTM”) models, gated recurrent unit (“GRU”) |
| | models, Markov processes, reinforcement learning |
| Non-Recurrent Models | Deep neural networks (“DNNs”), convolutional neural |
| | networks (“CNNs”), support vector machines (“SVMs”), |
| | anomaly detection (e.g., using principal component analysis |
| | (“PCA”), logistic regression, decision trees/forests, ensemble |
| | methods (e.g., combining models), |
| | polynomial/Bayesian/other regressions, stochastic gradient |
| | descent (“SGD”), linear discriminant analysis (“LDA”), |
| | quadratic discriminant analysis (“QDA”), nearest neighbors |
| | classifications/regression, naïve Bayes, etc. |

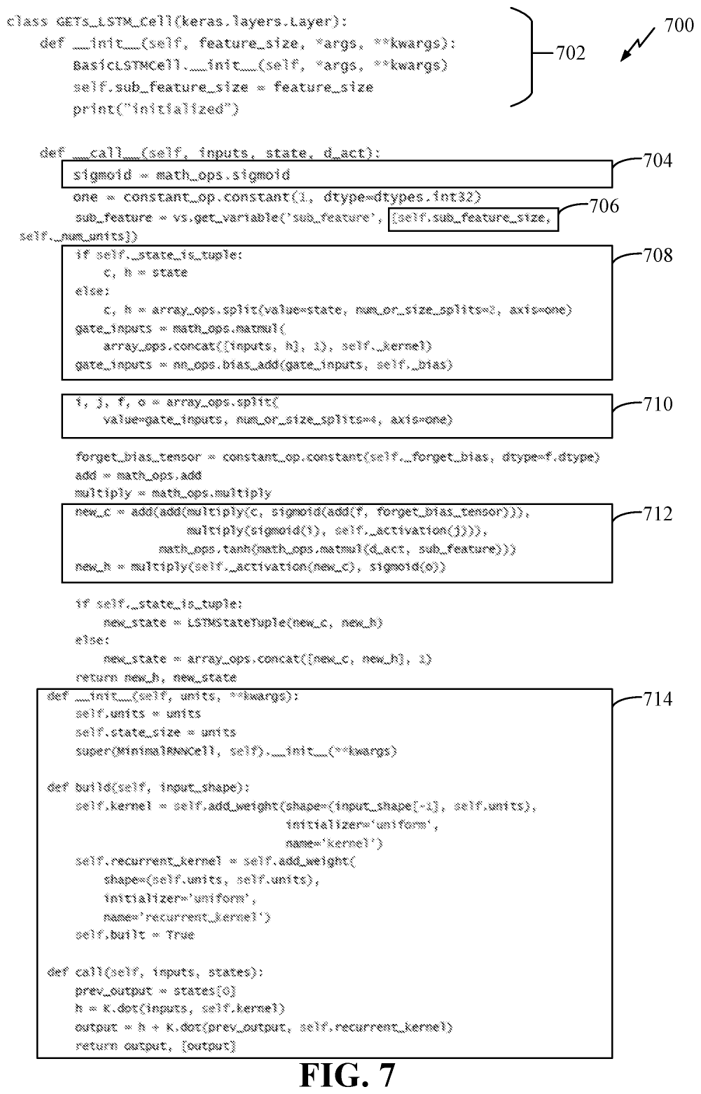

FIG. 7 illustrates an example of a programming code or pseudo-code 700 implementing a deep learning model according to an aspect of the disclosure. For example, the programming code 700 may implement the deep learning model that is conceptually illustrated in FIG. 6. In some examples, the programming code 700 may be in Python that is one of interpreted high-level general-purpose programming languages. However, it should be appreciated that any other suitable programming language can be used to implement the deep learning model illustrated in FIG. 6. The programming code 700 may include user defined functions. For example, the_init_ function 702 may indicate initialization of all arguments. The math_ops.simoid function may be an activation function that is shown as an input entity 622 in FIG. 6. The self.sub_feature_size argument 706 may indicate a new feature as input that is shown as hₜ₋₁ 624 in FIG. 6. The block 708 may process parameters for efficiency. In block 710, ‘i’ may indicate an input gate that is shown as block 626 in FIG. 6, ‘j’ may indicate a features input shown as block 634 in FIG. 6, ‘f may indicate a forget gate shown as block 632 in FIG. 6, and ‘o’ may indicate an output gate shown as block 630 in FIG. 6. Block 712 may add the features for calculation. Block 714 may use the indicated cell to start building the network. It should be appreciated that this programming code 700 is a mere example to help a person having ordinary skill in the art to implement the deep learning model in the real world. Any other suitable code to implement the deep learning model may be exploited.

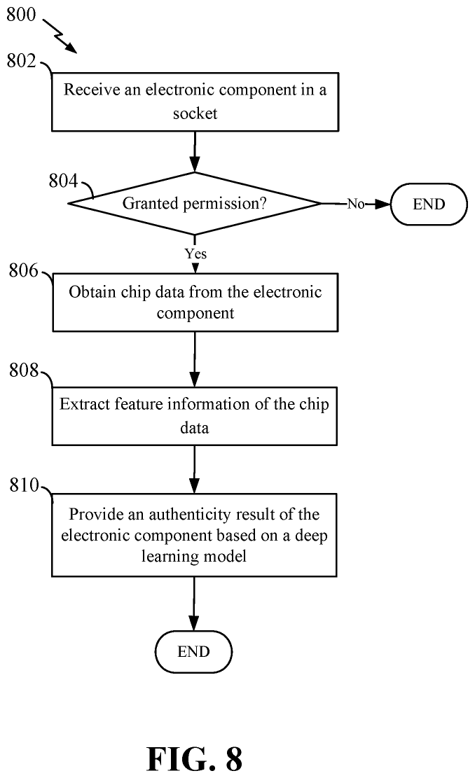

FIG. 8 is a flow chart illustrating an exemplary process for detecting authenticity of an electronic component according to an aspect of the disclosure. As described below, a particular implementation may omit some or all illustrated features and may not require some illustrated features to implement all embodiments. In some examples, any suitable apparatus or means for carrying out the functions or algorithm described below may carry out the process 800. An electronic component authenticity identification system 100 may include a socket to receive an electronic component, a server including a processor and a memory, and

At block 802, the system may receive an electronic component in the socket or otherwise make communicative connection with input/outputs of the electronic component. The electronic component may include an integrated circuit chip or any other suitable physical entity that is capable of communication with another suitable electronic circuit or device as explained above. In some examples, each pin (or other input/output) in the electronic component may be received by the socket and electrically coupled to the system 100. In some examples, the socket can include female connectors to receive male connectors (e.g., pins) of the electronic component. However, it should be appreciated that the electronic component can include other types of input/output ports than pins. For example, the electronic component can be reversed (i.e., pins included in the test system to interface with ports of the chip/component) or can include standard interface port (e.g., a USB port, etc.) for its input and output ports.

At block 804, the system 100 may check whether the user of the system is entitled to use the system 100. The system 100 may grant a permission to the user based on location information of the user of the electronic component. In some examples, the location information may include an internet protocol address. When the user is entitled to use the system, the system 100 may move forward to block 806. When the user is entitled to use the system, the system 100 may terminate the process 800. In other examples, the system 100 may check the permission before providing an authenticity indication to the user. Thus, the system 100 may provide the authenticity indication using the process 800 in response to the permission based on the location information of the user of the electronic component. In some examples, the system can determine permissions based on a real-time token or other authentication technique. The token can be a fixed string (e.g., 32-string) provided by an API. The string can indicate each different user's credentials and permission requirements. Once a server using the system 100 is under attack from a specific token (for example a flooding attack or DOS attack), the system 100 can grab and analyze information by using such tokens. In further examples, the system can block the requests from a suspicious token, but may not block their IP in order to maximize the convenience for users.

At block 806, the system 100 may obtain chip data from the electronic component. In some examples, obtaining the chip data may include testing each pin of the electronic component to be connected to another pin of the electronic component. In some examples, the system 100 may provide an alternating voltage (AC) to each pin-to-pin connection. In some scenarios, the system 100 may scan the electronic component twice and store two types of data for library: 1) The first type of data is the matching resistance required between each pin and pin, which is obtained by the first scan, and 2) the second type of data is the test data, which uses the matching resistance configuration generated by the first scan to scan the known good data between each pin-to-pin. In further examples, obtaining the chip data may further include determining time-series waveform data as a result of the testing. The time-series waveform data may, for example, be stored in multiple subfiles. The time-series waveform data may be data mapped from each pin of the electronic component to another pin of the electronic component. A subfile 202 may include time-series waveform data mapped from a pin of the electronic component to another pin of the electronic component. In some examples, the system may compress all subfiles into one compressed file (e.g., a tar file, a zip file, etc.). In further examples, obtaining the chip data may further include uploading the time-series waveform data to a deep learning model. In some examples, the system may use an API to transfer or upload the compressed file to a memory along with a processor of a server that run the deep learning model in the system 100. In some examples, the system 100 can indicate which pins are grounded or connected to power. Then, the system 100 can use the golden sample result as a reference to separately manage the result for those pins. For example, if a pin is marked as grounded pin or powered pin, the system 100 can have more strict passing tolerance for the pins.

At block 808, the system 100 may extract feature information of the chip data for reducing noise of the chip data. Since the original chip data included in the compressed file may include unwanted interference, the system 100 may reduce noise of the original chip data by extracting the feature information based on a polynomial function explained above. In some instances, the extracted feature information. The polynomial function for extracting the feature information may, for example, include: p(x)=Eᵢ₌₀ⁿαᵢxⁱ, where p(x) is extracted feature, αᵢ is a coefficient that minimizes a mean squared error, xⁱ is the chip data, and n is a degree. In some examples, the extracted feature may include multiple features. Each feature may include noise-reduced time-series waveform data from a pin to another pin of the electronic component. In further examples, the feature information can be the chip data or time-series waveform data.

At block 810, the system 100 may provide a user with an authenticity indication for the electronic component based on an output of the deep learning model. In some examples, the system 100 may provide the feature information of the chip data to the trained deep learning model. In further examples, the system may determine multiple impact weights based on an attention mechanism which adjust the multiple impact weights corresponding to multiple features in each training step. The deep learning model may further receive the multiple impact weights. Thus, the system 100 may determine the authenticity result based on the multiple impact weights corresponding to the multiple features, the multiple features, and the deep learning model. In some instances, the deep learning model is an artificial recurrent neural network (RNN) architecture using an input gate, an output gate, a forget gate, and a new input gate. The input gate corresponds to the plurality of features, the output gate corresponds to the result, the forget gate is determined based on an input vector and a hidden state vector, and the new input gate is determined based on the input vector and the hidden state vector as explained above. In some examples, the trained deep learning model can be trained with a plurality of feature information of training chip data sets and a plurality of authenticity ground truth labels corresponding to training chip data sets, the training chip data sets comprising an authentic chip data set and a counterfeit chip data set. In further examples, the trained deep learning model can be trained further with a plurality of model indications corresponding to the training chip data sets. Thus, the deep learning model can be trained not only based on the authenticity of the training electronic components but also the models of the training electronic components.

In some examples, the deep learning model can receive the collected time-series waveform data as input and produce the output (e.g., a probability of an authentic chip or a counterfeit chip). Thus, the system 100 can receive the electronic component (using a socket) and extract time-series waveform (e.g., pin-to-pin connection signals) by providing a voltage (e.g., an alternating voltage (AC) or various voltages) to each pin-to-pin connection of the electronic component. Then, the trained deep learning model can produce an authenticity result.

In further examples, the system 100 can train the deep learning model in a supervised way. For example, the system 100 can provide the labels of the chip model, the ground truth of chip authenticity results, and the collected waveform data from these chips as input for training the deep learning model. In some examples, the waveform data can include data of both authentic chips and counterfeit chips. Thus, the deep learning model can learn to determine the authenticity result based on chip models. For example, the system 100 can train time-series waveform data 1-1, 1-2, and 1-n with corresponding authenticity results for chip model 1. Further, the system 100 can train time-series waveform data 2-1, 2-2, and 2-n with corresponding authenticity results for chip model 2. In addition, the system 100 can train time-series waveform data m-1, m-2, and m-n with corresponding authenticity results for chip model m. Based on the training, the system 100 can produce an authenticity result of an electronic component. In further examples, the system 100 can additionally or internally produce a model result (e.g., a probability to be matched with the chip model (1, 2, or m) of the electronic component).

In some examples, the system 100 is an easy and convenient tool for performing quality conformance and counterfeit IC (integrated circuit) detection based on the deep learning model using neural networks. This authentication system 100 can conduct a quick open/short circuit check, leakage current check and supply current check to make sure all readings are within specification. Then, the system 100 can perform a matrix scan to scan from pin to pin to obtain physical characteristics (impedance based) which are processed and fed into our deep learning system to train our model, which is capable of producing the corresponding golden chip library. IC's usually have multiple pins that serve as electrical inputs/outputs and connect to the system through a printed circuit board. Due to this physical setup, an automated test and diagnostic system can be constructed to rapidly scan between pins thus forming an ‘electronic signature’ of the device under test (DUT). The automatic test can first transfer the scanned data to the diagnostic system and then speculate on the appropriate model to formulate its electronic signature. This is then rapidly compared to a known good device (KGD). Consequently, fast assessment of the authenticity of the part is thus possible.

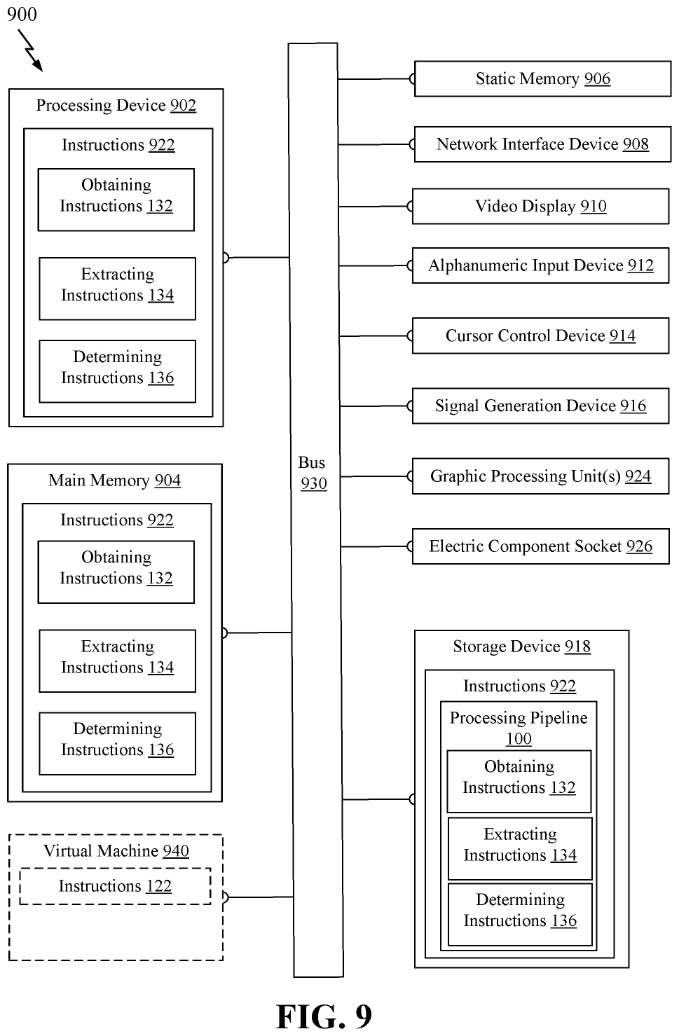

FIG. 9 is a block diagram conceptually illustrating an example machine of a computer system 900 within which a set of instructions, for causing the machine to perform any one or more of the methods disclosed herein, may be executed. In alternative implementations, the machine may be connected (such as networked) to other machines in a LAN, an intranet, an extranet, and/or the Internet.

The machine may operate in the capacity of a server or a client machine in a client-server network environment, as a peer machine in a peer-to-peer (or distributed) network environment, or as a server or a client machine in a cloud computing infrastructure or environment. The machine may be a server computer, a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methods discussed herein.

The example computer system 900 also includes a processing device 902, a main memory 904 (such as read-only memory (ROM), flash memory, dynamic random access memory (DRAM) such as synchronous DRAM (SDRAM) or DRAM, etc.), a static memory 906 (such as flash memory, static random access memory (SRAM), etc.), and a data storage device 918, which communicate with each other via a bus 930.

Processing device 902 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 902 may also be one or more special-purpose processing devices such as an application specific integrated circuit (ASIC), a field programmable gate array (FPGA), a digital signal processor (DSP), network processor, or the like. The processing device 902 is configured to execute instructions 922 for performing the operations and steps discussed herein.

The computer system 900 may further include a network interface device 908 for connecting to the LAN, intranet, internet, and/or the extranet. The computer system 900 also may include a video display unit 910 (such as a liquid crystal display (LCD) or a cathode ray tube (CRT)), an alphanumeric input device 912 (such as a keyboard), a cursor control device 914 (such as a mouse), a signal generation device 916 (such as a speaker), and a graphic processing unit 924 (such as a graphics card). The example computer system 900 may further include an electronic component socket 926 for receiving an electronic component to be determined as authentic or counterfeit.

The data storage device 918 may be a machine-readable storage medium 928 (also known as a computer-readable medium) on which is stored one or more sets of instructions or software 922 embodying any one or more of the methods or functions described herein. The instructions 922 may also reside, completely or at least partially, within the main memory 904 and/or within the processing device 902 during execution thereof by the computer system 900, the main memory 904 and the processing device 902 also constituting machine-readable storage media.

In one implementation, the instructions 922 include obtaining instructions for obtaining chip data of an electronic component, testing each pin of the electronic component to be connected to another pin of the electronic component, determining time-series waveform data based on the testing, uploading the time-series waveform data as the chip data of the electronic component to the deep learning model at block 806 of FIG. 8. The instructions 922 may further include extracting instructions 934 for extracting feature information of the chip data at block 808 of FIG. 8. The instructions 922 may further include determining instructions 936 for providing an authenticity result of the electronic component based on the deep learning model receiving the extracted feature information at block 810 of FIG. 8. While the machine-readable storage medium 918 is shown in an example implementation to be a single medium, the term “machine-readable storage medium” should be taken to include a single medium or multiple media (such as a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media. The term “machine-readable storage medium” shall accordingly exclude transitory storage mediums such as signals unless otherwise specified by identifying the machine readable storage medium as a transitory storage medium or transitory machine-readable storage medium.

In another implementation, a virtual machine 940 may include a module for executing instructions such as obtaining instructions 932, extracting instructions 934, and/or determining instructions 936. In computing, a virtual machine (VM) is an emulation of a computer system. Virtual machines are based on computer architectures and provide functionality of a physical computer. Their implementations may involve specialized hardware, software, or a combination of hardware and software.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “modifying” or “providing” or “calculating” or “determining” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices. The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct a more specialized apparatus to perform the method. The structure for a variety of these systems will appear as set forth in the description below. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (such as a computer). For example, a machine-readable (such as computer-readable) medium includes a machine (such as a computer) readable storage medium such as a read only memory (“ROM”), random access memory (“RAM”), magnetic disk storage media, optical storage media, flash memory devices, etc.

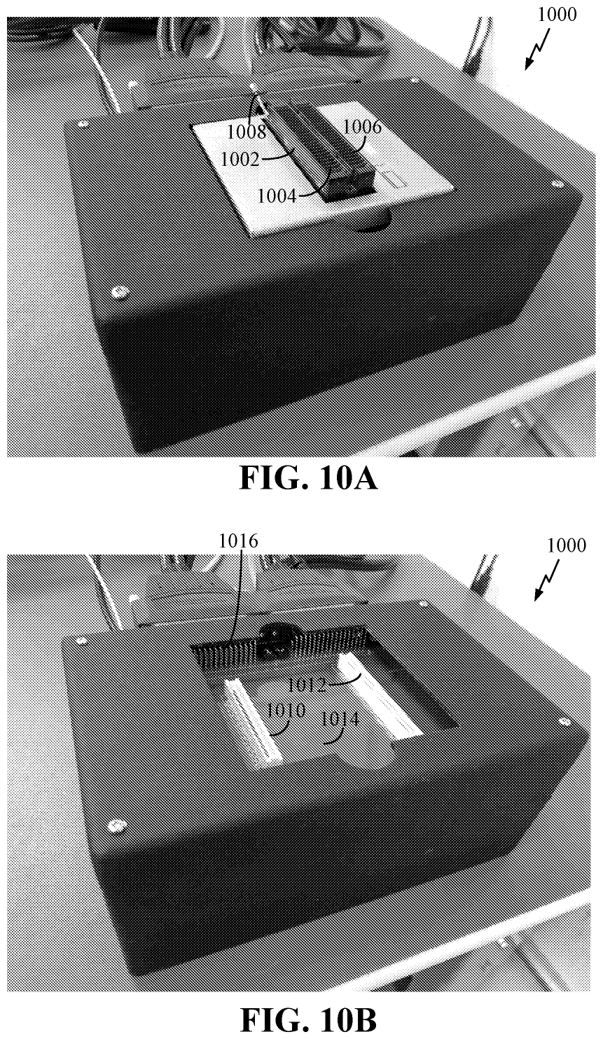

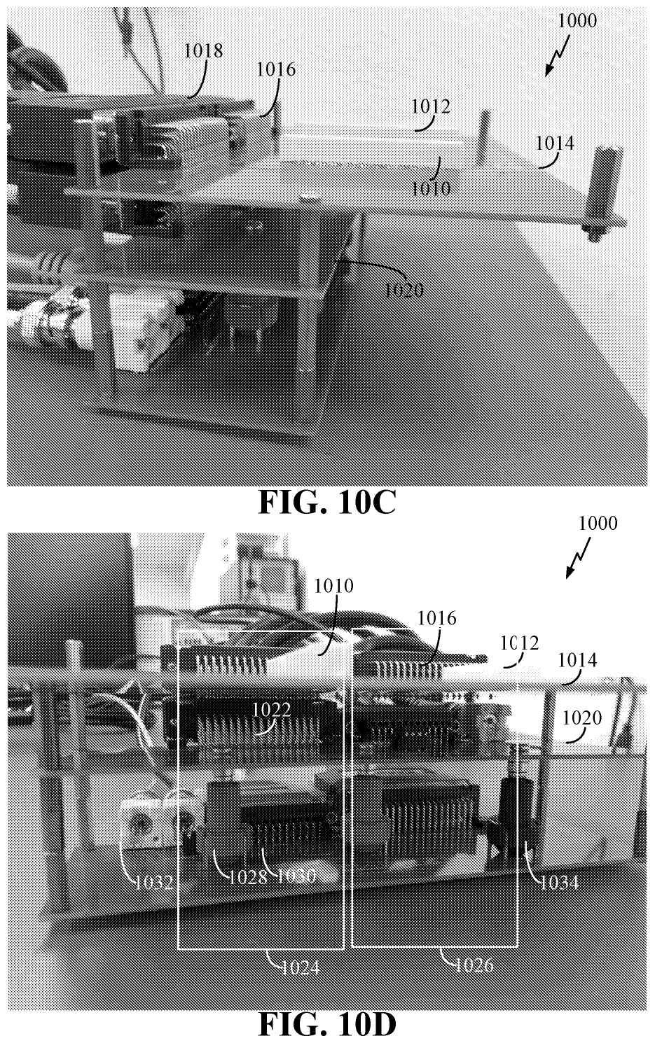

FIGS. 10A-10D show an example apparatus 1000 for electronic component authenticity identification according to some embodiments. For example, the apparatus 1000 can include a socket 1002 to receive an electronic component (e.g., an IC chip) as shown in FIG. 10A. In some examples, the electronic component may include multiple pins. A first set of pins can be aligned on a first row 1004 of the socket 1002 while a second set of pins can be aligned on a second row 1006 of the socket 1002. Each pin of the electronic component may be received by the socket 1002. When each pin of the electronic component is received in the socket 1002, the apparatus can increase the electrical coupling of the pins in the electronic component in the socket 1002 using a lever 1008. For example, the socket 1002 can include multiple holes on a surface of the socket 1002, and each pin of the electronic component can be received in a hole of the socket 1002. The socket 1002 can further include an electrical contact board including holes corresponding to the holes on the surface. In some examples, the electrical contact board is connected to the lever 1008. Thus, when a lever moves, holes through the surface to the electrical contact board become smaller. Thus, the electrical contact of the pins in the electronic component on the electrical contact board increases.

Referring to FIG. 10B, the socket 1002 is connected to a receiving components 1010, 1012. In some examples, the receiving component can include a first receiving component 1010 connected to the first row 1004 of the socket 1002 and a second receiving component 1012 connected to the second row 1006 of the socket 1002. The receiving components 1010, 1012 can be placed on a first electrical board 1014 of the apparatus 1000. In further examples, a first coil 1016 can be placed on the first electrical board 1014. The receiving components 1010 and 1012 can be connected to a socket board, which is connected to the socket 1002 then that socket board soldering connected to the socket 1002. In some examples, the first coil 1016 can be a female cable connector connected to the matrix switch instrument cable and our system board.

Referring to FIG. 10C, the coil 1016 on the first electrical board 1014 can be connected to a connector 1018. In some examples, the connector 1018 can be the male connector of the matrix switch instrument cable. These matrix switch connection cable can be used for sweeping the pins, the data acquisition will be done by an oscilloscope probe 1032.

Referring to FIGS. 10C and 10D, the apparatus 1000 can further include a second electrical board 1020. A second coil 1022 the coil 1016 on the first electrical board 1014 can be connected to a connector 1018. In some examples, a second coil 1030 can be used for generating AC signal input and DC power supply for the circuit board, the second coil 1030 can be connected to the national instruments (NI) source measure unit (SMU) instrument. In some example, a component 1028 can be the DC power supply separated from the second coil 1030. In some examples, the oscilloscope probe 1032 can acquire data used for the deep learning model training. Another component 1034 can be connected to the ground of middle layer board and bottom layer board. A third coil 1022 can be used for more accurate impedance calculations. It should be appreciated that the components in FIGS. 10A-10D are mere examples and any other suitable component can be used for electronic component authenticity determination.

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

What is claimed is:

1. A method for electronic component authenticity identification comprising:
obtaining chip data of an electronic component by providing a voltage to each pin-to-pin connection of the electronic component;
extracting feature information of the chip data for reducing noise of the chip data;
providing the feature information of the chip data to a trained deep learning model; and
providing a user with an authenticity indication for the electronic component based on an output of the trained deep learning model.

2. The method of claim 1, further comprising:
providing the authenticity indication in response to a permission based on location information of the user of the electronic component.

3. The method of claim 2, wherein the location information includes an internet protocol address.

4. The method of claim 1, wherein the chip data comprises: time-series waveform data mapped from each pin of the electronic component to another pin of the electronic component.

5. The method of claim 1, wherein the chip data is included in one compressed file.

6. The method of claim 5, wherein the one compressed file comprises a plurality of subfiles.

7. The method of claim 1, wherein the obtaining the chip data comprises:
testing each pin of the electronic component to be connected to another pin of the electronic component;
determining time-series waveform data based on the testing; and
uploading the time-series waveform data as the chip data of the electronic component to the trained deep learning model.

8. The method of claim 1, wherein the feature information is extracted based on the chip data applying a polynomial function.

9. The method of claim 8, wherein the polynomial function for extracting the feature information comprises: p(x)=Eᵢ₌₀ⁿαᵢxⁱ, where p(x) is an extracted feature, αᵢ is a coefficient that minimizes a mean squared error, x′ is the chip data, and n is a degree.

10. The method of claim 1, wherein the extracted feature information comprises a plurality of features.

11. The method of claim 10, further comprising:
determining a plurality of impact weights based on an attention mechanism; and
determining the output of the trained deep learning model based on the plurality of impact weights corresponding to the plurality of features.

12. The method of claim 11, wherein the trained deep learning model is an artificial recurrent neural network (RNN) architecture using an input gate, an output gate, a forget gate, and a new input gate, and
wherein the input gate corresponds to the plurality of features, the output gate corresponds to the output, the forget gate is determined based on an input vector and a hidden state vector, and the new input gate is determined based on the input vector and the hidden state vector.

13. The method of claim 1, wherein the trained deep learning model is trained with a plurality of feature information of training chip data sets and a plurality of authenticity ground truth labels corresponding to training chip data sets, the training chip data sets comprising an authentic chip data set and a counterfeit chip data set.

14. The method of claim 13, wherein the trained deep learning model is trained further with a plurality of model indications corresponding to the training chip data sets.

15. An electronic component authenticity identification system comprising:
a socket for receiving an electronic component;
a processor; and
a memory having stored thereon a set of instructions which, when executed by the processor, cause the processor to:
obtain chip data of the electronic component by providing a voltage to each pin-to-pin connection of the electronic component;
extract feature information of the chip data;
provide the feature information of the chip data to a trained deep learning model; and
provide a user with an authenticity indication for the electronic component based on an output of the trained deep learning model.

16. The electronic component authenticity identification system of claim 15, wherein the set of instructions which further cause the processor to:
provide the authenticity indication in response to a permission based on location information of the user of the electronic component.

17. The electronic component authenticity identification system of claim 16, wherein the location information includes an internet protocol address.

18. The electronic component authenticity identification system of claim 15, wherein the chip data comprises: time-series waveform data mapped from each pin of the electronic component to another pin of the electronic component.

19. The electronic component authenticity identification system of claim 15, wherein the chip data is included in one compressed file.

20. The electronic component authenticity identification system of claim 19, wherein the one compressed file comprises a plurality of subfiles.

21. The electronic component authenticity identification system of claim 15, wherein the set of instructions which further cause the processor to:
test each pin of the electronic component to be connected to another pin of the electronic component;
determine time-series waveform data based on the testing; and
upload the time-series waveform data as the chip data of the electronic component to the trained deep learning model.

22. The electronic component authenticity identification system of claim 15, wherein the feature information is extracted based on the chip data by applying a polynomial function.

23. The electronic component authenticity identification system of claim 22, wherein the polynomial function for extracting the feature information comprises: p(x)=Σᵢ₌₀ⁿαᵢxⁱ, where p(x) is an extracted feature, αᵢ is a coefficient that minimizes a mean squared error, xⁱ is the chip data, and n is a degree.

24. The electronic component authenticity identification system of claim 15, wherein the extracted feature information comprises a plurality of features.

25. The electronic component authenticity identification system of claim 24, wherein the set of instructions which further cause the processor to:
determine a plurality of impact weights based on an attention mechanism; and
determine the output of the trained deep learning model based on the plurality of impact weights corresponding to the plurality of features.

26. The electronic component authenticity identification system of claim 25, wherein the trained deep learning model is an artificial recurrent neural network (RNN) architecture using an input gate, an output gate, a forget gate, and a new input gate, and
wherein the input gate corresponds to the plurality of features, the output gate corresponds to the output, the forget gate is determined based on an input vector and a hidden state vector, and the new input gate is determined based on the input vector and the hidden state vector.

27. The electronic component authenticity identification system of claim 15, wherein the trained deep learning model is trained with a plurality of feature information of training chip data sets and a plurality of authenticity ground truth labels corresponding to training chip data sets, the training chip data sets comprising an authentic chip data set and a counterfeit chip data set.

28. The electronic component authenticity identification system of claim 27, wherein the trained deep learning model is trained further with a plurality of model indications corresponding to the training chip data sets.
